(19) United States
(12) Patent Application Publication
(10) Pub. No.: US 2008/0148875 A1
(43) Pub. Date: Jun. 26, 2008

(54) Inspection method and apparatus, lithographic apparatus, lithographic processing cell and device manufacturing method

(75) Inventors: Thomas Leo Maria Hoogenboom, Breda (NL); Reinder Teun Plug, Eindhoven (NL); Maurits Van Der Schaar, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/641,944

(22) Filed: Dec. 20, 2006

(51) Int. Cl. G01M 19/00

(52) U.S. Cl. 73/865.8

(57) ABSTRACT

Two drive systems are responsible for moving a substrate beneath, for example, an illumination system or a measurement radiation beam. A first drive system drives a substrate in a X direction and a second drive system drives the substrate in a Y direction. In order to make a measurement of a feature of the substrate surface, targets are arranged in a lattice. Rather than having the lattice aligned with the X and Y directions such that only one drive system operates at a time to step between the targets, the lattice of targets is arranged at an angle with respect to the X and Y axes such that both drive systems operate simultaneously in order to move between the targets. The targets (or sub-targets within the targets) may also be arranged with respect to each other so as to save scribelane space and to create a most economical path between them.

### FIELD

The present invention relates to a method of inspection usable, for example, in the manufacture of devices by a lithographic technique and to a method of manufacturing devices using a lithographic technique. The present invention is also applicable to any automated system that scans a surface to be worked on in a two-dimensional plane, such as a metalworking tool or an etching system.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to monitor the lithographic process, one or more parameters of the patterned substrate are typically measured, for example the overlay error between successive layers formed in or on the substrate. There are various techniques for making measurements of the microscopic structures formed in a lithographic process, including the use of a scanning electron microscope and various specialized tools. One form of specialized inspection tool is a scatterometer in which a beam of radiation is directed onto a target on the surface of the substrate and one or more properties of the scattered or reflected beam are measured. By comparing one or more properties of the beam before and after it has been reflected or scattered by the substrate, one or more properties of the substrate may be determined. This may be done, for example, by comparing the reflected beam with data stored in a library of known measurements associated with a known substrate property. Two main types of scatterometer are known. A spectroscopic scatterometer directs a broadband radiation beam onto the substrate and measures the spectrum (intensity as a function of wavelength) of the radiation scattered into a particular narrow angular range. An angularly resolved scatterometer uses a monochromatic radiation beam and measures the intensity of the scattered radiation as a function of angle. An ellipsometer measures polarization state.

### SUMMARY

Several types of measurement are typically made of the substrate using a scatterometer. A first measurement is that of the alignment of the substrate with respect to a reference outside the substrate. A second type of measurement is an overlay measurement which measures overlay between different layers on the substrate. A further measurement includes the reconstruction of the profile of a target with a known shape in order to determine discrepancies in shape formation of a structure on the substrate surface. These and other measurements require the use of a target on the substrate surface.

Generally, a plurality of targets are used in measurements on the substrate in order to be able to obtain an average or a trend over the plurality of targets. Each of the targets may, for example, comprise a grating with the bars of the grating oriented in different directions in order to obtain alignment or overlay or profile data in a number of degrees of freedom.

An example of a substrate W containing a series of targets 200 is shown in FIG. 4. As can be seen from FIG. 4, the targets 200 are aligned in a lattice, this lattice being aligned with the X-Y coordinates of the substrate itself. In other words, the targets to be measured occupy positions arranged on a regular X-Y grid, typically a target location that is related to a field in a substrate layout. The targets are measured individually, the sequence of measurements being determined by the shortest path between targets in order to minimize travel time. In most situations, the shortest path is a meander as shown in FIG. 4. The path between each of the targets is shown with arrows labeled with reference numeral 100.

In order to move between the targets, the substrate is typically moved below a static sensor system. There are two drive systems that move the substrate—a first drive system moves the substrate in the X direction and a second drive system moves the substrate in the Y direction. In a further embodiment, the sensor system is moved in a first direction (e.g. along the X-axis) and the substrate is moved in the perpendicular axis (the Y-axis). In either embodiment, when moving from target to target in a meander fashion as shown in FIG. 4, only one of the drive systems is active at a time. Each of the drive systems has a maximum power output and therefore a maximum acceleration. Specifically, when the time available in which to move is limited, the acceleration possible limits the maximum achievable speed. In other words, the available power contributes in determining the minimum travel time for a given path.

By using only one of the drive systems at a time, only 50% of the power available to reposition the target is used. In other words, by having a dormant drive system during any of the movements 100, the power available from that dormant drive system is not being put to use, thus making the overall system not 100% efficient. Assuming the drive systems in both the X and Y directions are equivalent, a full 50% of the potential power is left unused per movement 100.

Furthermore, each measurement target is typically made up of a plurality of smaller targets, between which the drive systems also cause the measurement beam to travel. The path traveled between the smaller (sub-) targets is known as a microstep. By having the sub-targets also arranged in a lattice, this may not make optimum use of available substrate “real estate”, as there may be a large amount of useless space between these sub-targets.

It is desirable, for example, to provide a system that enables the use of as much of the power of the drive system(s) as possible when moving from one target to the next on a substrate.

According to an aspect of the invention, there is provided a method of measuring a property of a substrate, in a system that comprises at least two drive systems configured to drive the substrate in substantially perpendicular drive directions, the substrate comprising at least two measurement targets for consecutive measurement, the method comprising:

positioning the substrate such that a most economical path between consecutive measurement targets is at an acute angle with respect to at least one of the substantially perpendicular drive directions of the at least two drive systems; and

driving the substrate using both drive systems simultaneously such that their net movement moves the substrate along the angle.

There may alternatively be only one measurement target and the most economical path is from a starting point to the one measurement target. By “substantially perpendicular”, it should be understood that the drive directions may be at 90 degrees to each other, or they may be at any non-zero angle that allows movement of the substrate in any direction such that the measurement targets on the substrate may be visited in turn by a measurement radiation beam.

According to another aspect of the invention, there is provided a loading apparatus for loading a substrate onto a substrate table for subsequent measurement, the substrate table being drivable by at least two drive systems with substantially perpendicular drive directions, the loading apparatus comprising:

a detector configured to detect a marker on the substrate indicating the X-Y axes of the substrate, the X-Y axes being determined by the relative position of measurement targets on the substrate; and

a positioning mechanism configured to position the substrate on the substrate table such that the X-Y axes of the substrate are at an acute angle with respect to at least one of the substantially perpendicular axes of the at least two drive systems.

According to yet another aspect of the invention, there is provided an inspection apparatus, lithographic apparatus or lithographic cell configured to measure a property of a substrate comprising:

a substrate table configured to hold a substrate;

a first drive system configured to drive the substrate table in a first direction;

a second drive system configured to drive the substrate table in a direction substantially perpendicular to the first direction; and

a loader configured to load a substrate onto the substrate table such that a most economical (e.g., shortest) direction of travel between at least a first measurement target and second measurement target on the substrate is at an acute angle with respect to at least one of the drive directions of the first and second drive systems.

According to a further aspect of the invention, there is provided a substrate for use in an inspection apparatus configured to measure a property of the substrate (e.g., in order to determine the accuracy of printing on the substrate), the substrate comprising a measurement target configured to redirect a measurement radiation beam, the measurement target comprising a plurality of sub-targets, the sub-targets being substantially circular and being arranged such that the sub-targets are packed as closely as possible to each other within the measurement target. The sub-targets are, of course, not limited to a square or circle shape. They can be any shape that can be packed closely while containing sufficient space for radiation redirecting structures. Possible shapes may be based on rectangles and hexagons, for instance.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1a depicts a lithographic apparatus;

FIG. 1b depicts a lithographic cell or cluster;

FIG. 2 depicts a scatterometer;

FIG. 3 depicts a further scatterometer;

FIG. 4 depicts a path of a substrate;

FIG. 5A depicts a rotated substrate according to an embodiment of the invention;

FIG. 5B depicts a rotated drive system according to an embodiment of the invention;

FIG. 6 depicts a standard arrangement of sub-targets;

FIG. 7 depicts a further standard arrangement of sub-targets;

FIG. 8 depicts an arrangement of sub-targets according to an embodiment of the invention;

FIG. 9 depicts an arrangement of sub-targets according to a further embodiment of the invention;

FIG. 10 depicts a loader configured to load a substrate;

FIG. 11 depicts a substrate according to an embodiment of the invention; and

FIG. 12 depicts a substrate according to a further embodiment of the invention.

### DETAILED DESCRIPTION

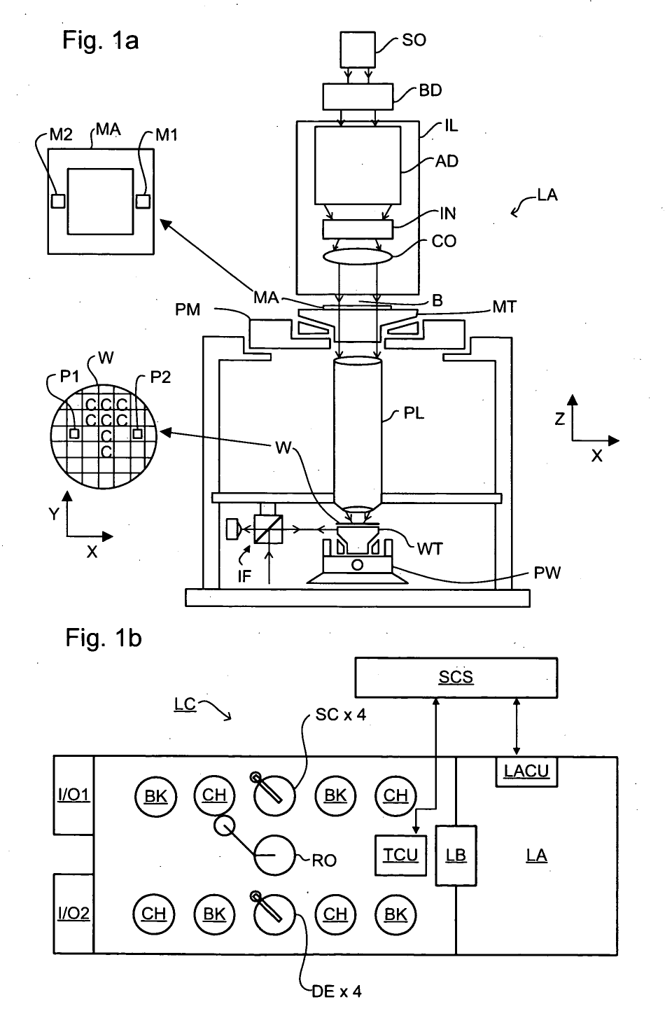

FIG. 1a schematically depicts a lithographic apparatus. The apparatus comprises:

an illumination system (illuminator) IL configured to condition a radiation beam B (e.g. UV radiation or EUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PL configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more support structures). In such “multiple stage” machines the additional tables and/or support structures may be used in parallel, or preparatory steps may be carried out on one or more tables and/or support structures while one or more other tables and/or support structures are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1a, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PL, which focuses the beam onto a target portion C of the substrate W. With the aid of the second positioner PW and position sensor IF (e.g. an interferometric device, linear encoder, 2-D encoder or capacitive sensor), the substrate table WT can be moved accurately, e.g. so as to position different target portions C in the path of the radiation beam B. Similarly, the first positioner PM and another position sensor (which is not explicitly depicted in FIG. 1a) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 1b, the lithographic apparatus LA forms part of a lithographic cell LC, also sometimes referred to as a lithocell or lithocluster, which also includes apparatus to perform one or more pre- and post-exposure processes on a substrate. Conventionally these include one or more spin coaters SC to deposit a resist layer, one or more developers DE to develop exposed resist, one or more chill plates CH and one or more bake plates BK. A substrate handler, or robot, RO picks up a substrate from input/output ports I/O1, I/O2, moves it between the different process devices and delivers it to the loading bay LB of the lithographic apparatus. These devices, which are often collectively referred to as the track, are under the control of a track control unit TCU which is itself controlled by the supervisory control system SCS, which also controls the lithographic apparatus via lithographic control unit LACU. Thus, the different apparatus may be operated to maximize throughput and processing efficiency.

In order that the substrate that is exposed by the lithographic apparatus is exposed correctly and consistently, it is desirable to inspect an exposed substrate to measure one or more properties such as overlay error between subsequent layers, line thickness, critical dimension (CD), etc. If an error is detected, an adjustment may be made to an exposure of one or more subsequent substrates, especially if the inspection can be done soon and fast enough that another substrate of the same batch is still to be exposed. Also, an already exposed substrate may be stripped and reworked—to improve yield—or discarded—thereby avoiding performing an exposure on a substrate that is known to be faulty. In a case where only some target portions of a substrate are faulty, a further exposure may be performed only on those target portions which are good. Another possibility is to adapt a setting of a subsequent process step to compensate for the error, e.g. the time of a trim etch step can be adjusted to compensate for substrate-to-substrate CD variation resulting from the lithographic process step.

An inspection apparatus is used to determine one or more properties of a substrate, and in particular, how one or more properties of different substrates or different layers of the same substrate vary from layer to layer and/or across a substrate. The inspection apparatus may be integrated into the lithographic apparatus LA or the lithocell LC or may be a stand-alone device. To enable most rapid measurements, it is desirable that the inspection apparatus measure one or more properties in the exposed resist layer immediately after the exposure. However, the latent image in the resist has a very low contrast—there is only a very small difference in refractive index between the part of the resist which has been exposed to radiation and that which has not—and not all inspection apparatus have sufficient sensitivity to make useful measurements of the latent image. Therefore measurements may be taken after the post-exposure bake step (PEB) which is customarily the first step carried out on an exposed substrate and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibility for rework of a faulty substrate but may still provide useful information, e.g. for the purpose of process control.

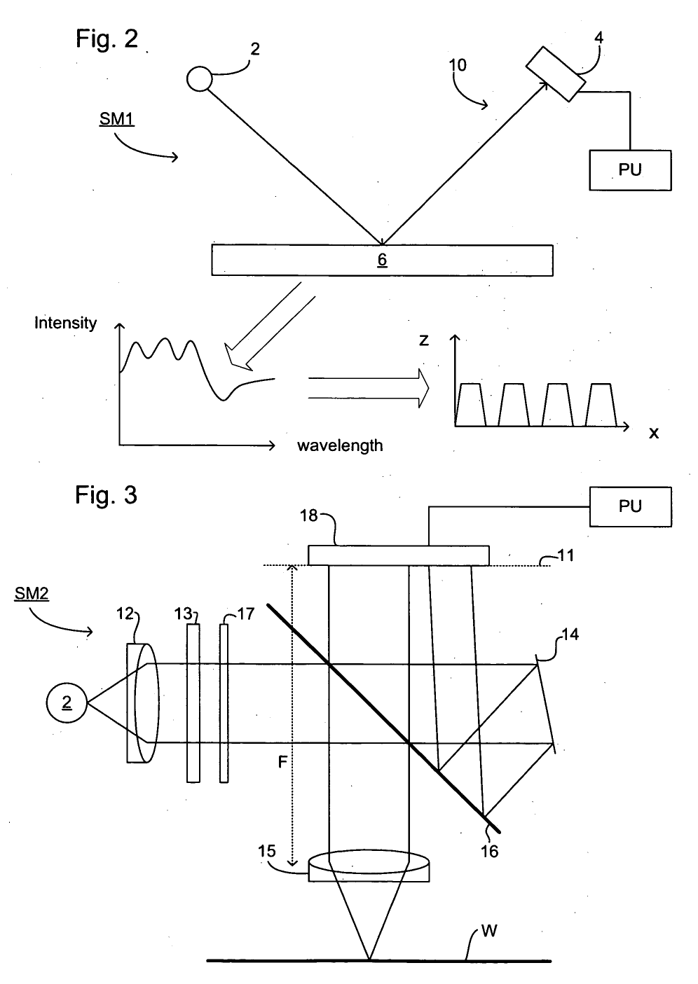

FIG. 2 depicts a scatterometer SM1 which may be used in an embodiment of the invention. It comprises a broadband (white light) radiation projector 2 which projects radiation onto a substrate W. The reflected radiation is passed to a spectrometer detector 4, which measures a spectrum 10 (i.e. a measurement of intensity as a function of wavelength) of the specular reflected radiation. From this data, the structure or profile giving rise to the detected spectrum may be reconstructed by processing unit PU, e.g. by Rigorous Coupled Wave Analysis and non-linear regression or by comparison with a library of simulated spectra as shown at the bottom of FIG. 2. In general, for the reconstruction, the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

Another scatterometer SM2 that may be used with an embodiment of the invention is shown in FIG. 3. In this device, the radiation emitted by radiation source 2 is focused using lens system 12 through interference filter 13 and polarizer 17, reflected by partially reflective surface 16 and is focused onto substrate W via a microscope objective lens 15, which has a high numerical aperture (NA), desirably at least 0.9 or at least 0.95. An immersion scatterometer may even have a lens with a numerical aperture over 1. The reflected radiation then transmits through partially reflective surface 16 into a detector 18 in order to have the scatter spectrum detected. The detector may be located in the back-projected pupil plane 11, which is at the focal length of the lens 15, however the pupil plane may instead be re-imaged with auxiliary optics (not shown) onto the detector 18. The pupil plane is the plane in which the radial position of radiation defines the angle of incidence and the angular position defines the azimuth angle of the radiation. The detector is desirably a two-dimensional detector so that a two-dimensional angular scatter spectrum (i.e. a measurement of intensity as a function of angle of scatter) of the substrate target can be measured. The detector 18 may be, for example, an array of CCD or CMOS sensors, and may have an integration time of, for example, 40 milliseconds per frame.

A reference beam is often used, for example, to measure the intensity of the incident radiation. To do this, when the radiation beam is incident on the partially reflective surface 16 part of it is transmitted through the surface as a reference beam towards a reference mirror 14. The reference beam is then projected onto a different part of the same detector 18.

One or more interference filters 13 are available to select a wavelength of interest in the range of, say, 405-790 nm or even lower, such as 200-300 nm. The interference filter(s) may be tunable rather than comprising a set of different filters. A grating could be used instead of or in addition to one or more interference filters.

The detector 18 may measure the intensity of scattered radiation at a single wavelength (or narrow wavelength range), the intensity separately at multiple wavelengths or the intensity integrated over a wavelength range. Further, the detector may separately measure the intensity of transverse magnetic—(TM) and transverse electric—(TE) polarized radiation and/or the phase difference between the transverse magnetic- and transverse electric-polarized radiation.

Using a broadband radiation source 2 (i.e. one with a wide range of radiation frequencies or wavelengths—and therefore of colors) is possible, which gives a large etendue, allowing the mixing of multiple wavelengths. The plurality of wavelengths in the broadband desirably each has a bandwidth of δλ and a spacing of at least 2δλ (i.e. twice the wavelength bandwidth). Several “sources” of radiation may be different portions of an extended radiation source which have been split using, e.g., fiber bundles. In this way, angle resolved scatter spectra may be measured at multiple wavelengths in parallel. A 3-D spectrum (wavelength and two different angles) may be measured, which contains more information than a 2-D spectrum. This allows more information to be measured which increases metrology process robustness. This is described in more detail in U.S. patent application publication no. US 2006-0066855, which document is hereby incorporated in its entirety by reference.

The target on substrate W may be a grating which is printed such that after development, the bars are formed of solid resist lines. The bars may alternatively be etched into the substrate. The target pattern is chosen to be sensitive to a parameter of interest, such as focus, dose, overlay, chromatic aberration in the lithographic projection apparatus, etc., such that variation in the relevant parameter will manifest as variation in the printed target. For example, the target pattern may be sensitive to chromatic aberration in the lithographic projection apparatus, particularly the projection system PL, and illumination symmetry and the presence of such aberration will manifest itself in a variation in the printed target pattern. Accordingly, the scatterometry data of the printed target pattern is used to reconstruct the target pattern. The parameters of the target pattern, such as line width and shape, may be input to the reconstruction process, performed by a processing unit, from knowledge of the printing step and/or other scatterometry processes.

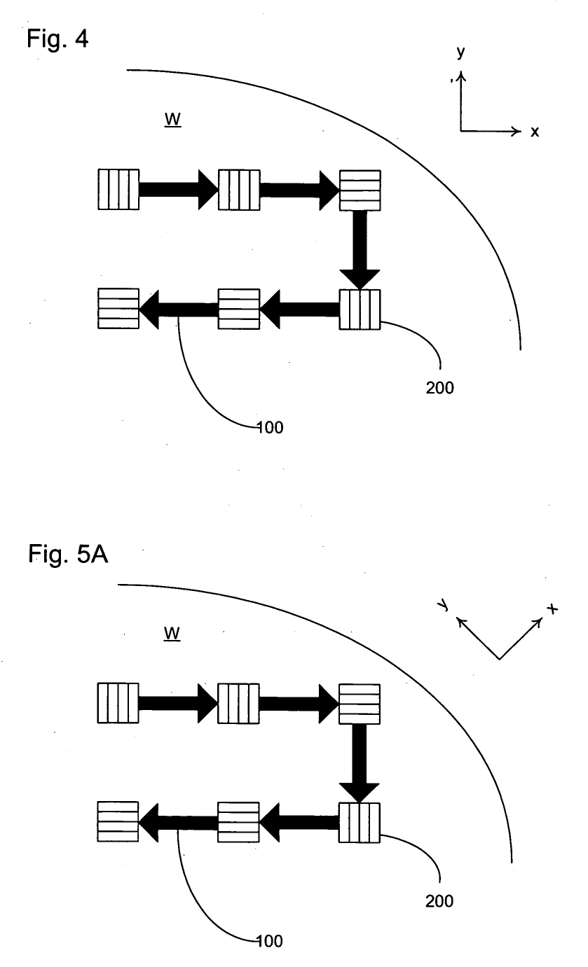

As discussed above, when scatterometry is used to measure a substrate surface, several targets (or at least sub-targets of a single target) are generally used. These targets will have different orientations, positions or relative sizes so that variations in the target characteristics can be measured and a complete picture of various parameters can be determined as described briefly above. The substrate is moved underneath, for example, an alignment beam using two drive systems. The first drive system will drive the substrate in the X direction and the second drive system will drive the substrate in a (substantially perpendicular) Y direction. The targets on the surface of the substrate are generally arranged in a grid aligned with the X- and Y-axes. In order to travel between the targets, therefore, one drive system operates at a time. As shown in FIG. 4, for example, the drive system that drives the substrate W in the X direction will be solely operating when moving the substrate W in the X direction and the drive system that drives the substrate W in the Y direction will operate solely when the substrate W is being moved in the Y direction. In an embodiment, one or both of the drive systems may be used to drive a portion of the scatterometer with respect to the substrate W.

The way that the drive systems are optimized (i.e. both used to their maximum capability rather than sitting idle while the other works) in an embodiment of the present invention is by turning the axis of the substrate by, for example, 45°. (The actual angle will have other parameters affecting it, as discussed below.). Specifically, the axis of the substrate W will be turned by 45° with respect to the drive axes of the drive systems PW if both drive systems have the same power output. This way, to move in the Y-direction, both drive systems will be working simultaneously. If both use their maximum power output, the speed of the movement of the substrate will be significantly greater than if only a single drive system is putting in the power and doing the work.

In fact, the angle of rotation of the axis of the substrate will vary depending on the relative power of both drive systems. If one drive system is more powerful than the other, to optimize the use of their power, the angle will be greater away from the direction of the stronger drive system so that its greater power compensates for the drive system with the lesser power. In this way, a weaker system may also be compensated for. As a specific example, if the drive system on the Y-axis is twice as powerful as the drive system on the X-axis, the substrate axis would be turned to, say, 22.5° from the X-axis (ignoring other parameters that affect the angle such as the mass of the substrate being moved as discussed below) so that both X- and Y-axis drive systems operating at maximum power would move the substrate in a straight line on the 45° axis between the X- and Y-axes.

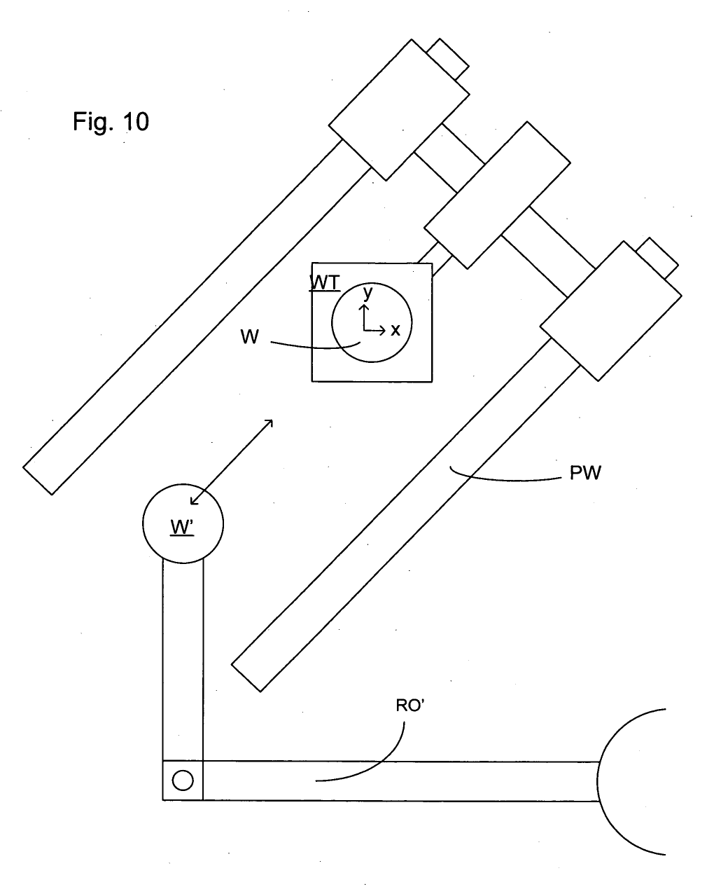

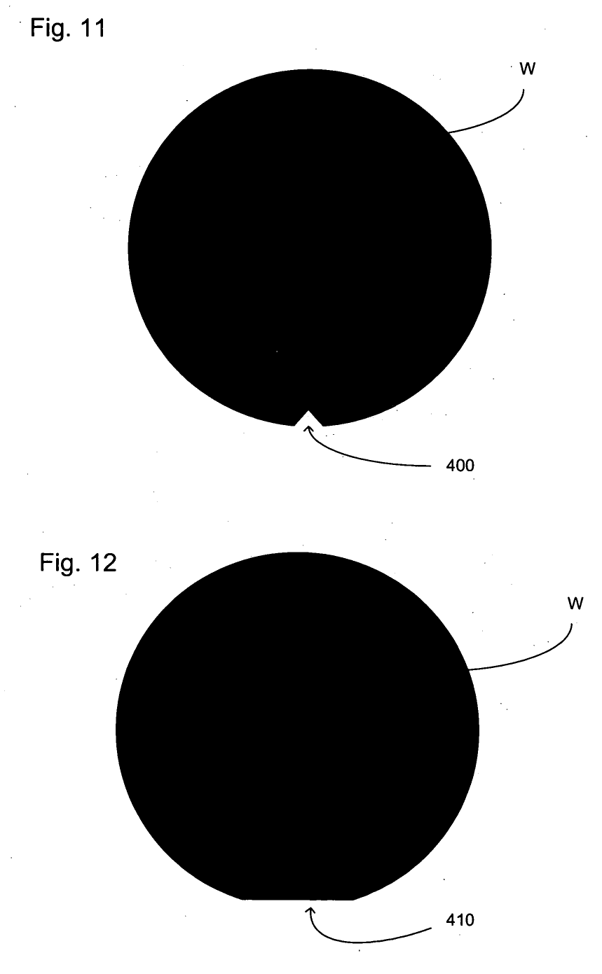

A loader RO′ such as shown in FIG. 10 supplies the substrate W′ to replace a substrate W. The loader must carefully load the substrate W′ and a robotic arm is generally used as described in association with the lithographic cell above. The way that the loader RO′ is able to distinguish the orientation is by a notch 400 such as that shown in FIG. 11 or a flat edge 410 of the generally circular substrate W as shown in FIG. 12.

The power ratings of the drive systems are measured by the maximum velocity and maximum acceleration of the X and Y drive systems. The drive systems also have a finite settling time (because of, for example, the momentum of the substrate, which is dependent on its mass), which is a combination of deceleration time and time spent regaining stability. If the X and Y drive systems have different power ratings or require different settling times, the angle of rotation of the axis of the substrate W can be accordingly adapted. The best angle may be found by simulating or measuring the total travel time for a typical meander pattern for a number of different angles, and picking that angle which gives the shortest total travel time.

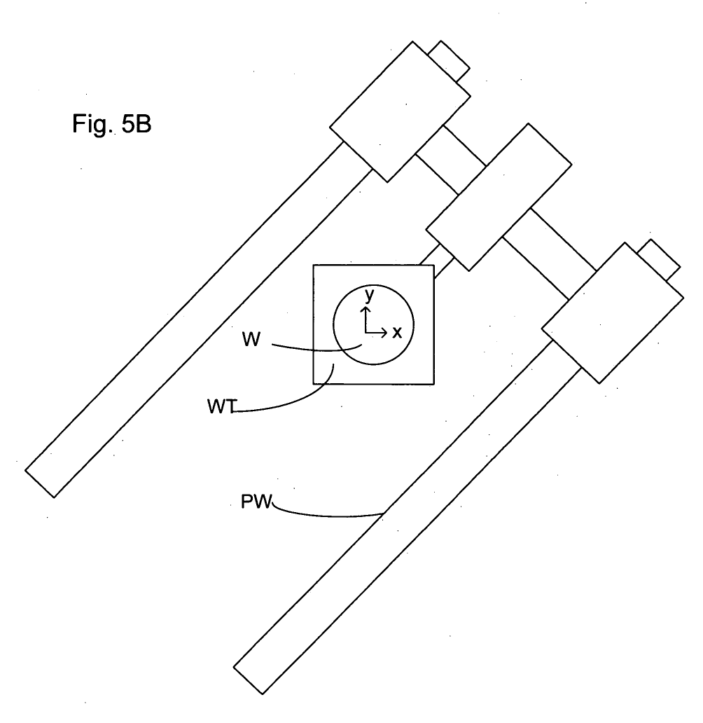

Referring to FIG. 5A and FIG. 5B, if the axis of the substrate W is rotated by 45° by rotating the substrate W (FIG. 5A) and/or rotating the substrate drive systems PW (FIG. 5B), both drive systems will be used simultaneously to move the substrate during each re-positioning step 100. The steps 100 taken between the targets 200 are each therefore enabled by both drive systems simultaneously. The speed of each step 100 may therefore be increased and the time taken to step between each target 200 may be decreased.

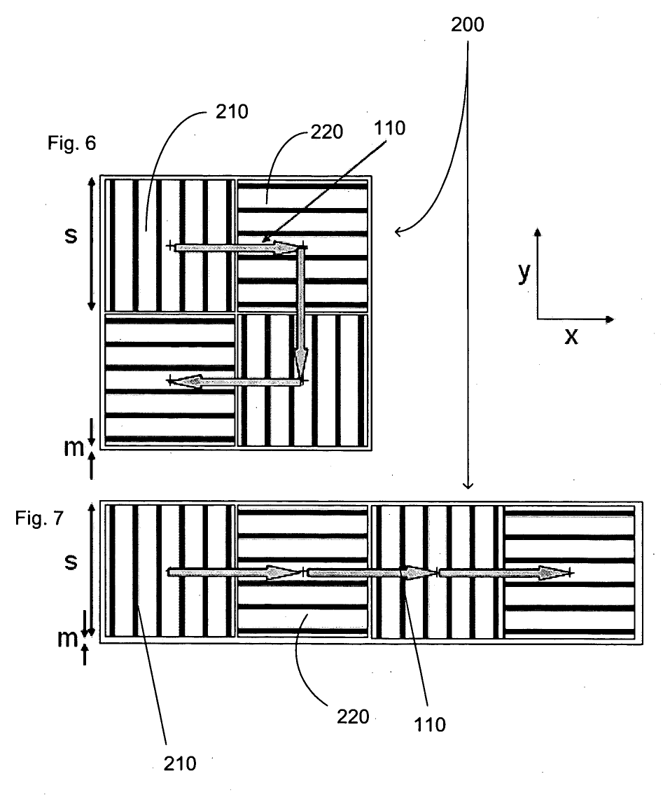

Similarly, when each target 200 comprises multiple sub-targets 210, 220 that are visited separately as shown in FIG. 6 or 7, arranging the axis of the sub-target steps 110 at a (e.g.) 45° angle will reduce the micro-step time required to travel from one sub-target 210 to the next 220. For example, the entire substrate with a grid of targets may be rotated and/or at the time of applying the targets to the substrate, the grid of targets may be rotated by the predetermined angle. Furthermore, the lattice of sub-targets 210, 220 may be applied to the substrate in an orientation rotated by the predetermined angle. Further embodiments of the precise orientation of the sub-targets will be discussed below.

According to an example, there may be 36 targets 200 on a substrate surface. Assuming a meander pattern provides the most economical, i.e. shortest, path, a known design requires approximately 25 seconds per substrate. Using a standard drive system, each step takes approximately 0.5 seconds, for a total travel time of 17.5 seconds (with 35 steps between the 36 targets).

With the axes rotated 45° relative to the substrate and a lattice of targets, double the power is available (from double the number of drive systems). The travel speed will increase by a factor of \sqrt{2}, so the total stepping time is reduced to 12.4 seconds. The gain of 5 seconds (17.5 minus 12.4) represents a 20% increase in substrate throughput compared to the standard drive system.

Further, the detector or sensor that is receiving the measurement beam once it has been redirected (e.g., reflected, refracted, scattered, etc.) from the measurement target can be rotated at the same angle as the substrate so that the redirected beam does not need to undergo any adjustment before being detected.

An embodiment of the invention may be applied to sub-targets 210, 220, 230 within a measurement target. The substrate is moved beneath a measurement beam in such a way that sub-targets within a target as shown in FIG. 6, for example, are irradiated one after the other. FIG. 6 shows a standard geometry for a target containing 4 sub-targets. Each sub-target has a standard height s. The measurement target also has a small grace margin m to separate the measurement sub-targets 210, 220 from a product die. Arrows 110 show the meander path within the measurement target of the movement of the substrate. First the top left sub-target 210 is irradiated, then the top right sub-target 220 and so on. FIG. 7 shows an alternative standard geometry, where the sub-targets 210, 220 are aligned in a single row one sub-target width s high (plus grace margin m).

Each sub-target itself comprises a grid which is scanned with parallel sweeps in a specific direction. In the standard geometries shown in FIGS. 6 and 7, the time required to complete a microstep 110 can be reduced if the direction of motion is parallel to the orientation of the sub-target grid because a shorter settling time can be adopted if a microstep becomes a sweep (and does not have to change direction first). For a 2 sub-target by 2 sub-target (i.e. with a size of 2s×2s) measurement target shown in FIG. 6, the direction of motion is parallel each of the 3 steps 110 shown. For the 1 by 4 (1s×4s) target shown in FIG. 7, the direction of motion is parallel for 2 of the 3 microsteps 110. The order in which the sub-targets are scanned is therefore significant for the throughput of the substrate as a whole.

As mentioned above, the axis of the sub-targets can be rotated (e.g., by rotating the sub-targets, applying the sub-targets in a rotated manner, having the drive systems arranged in a rotated manner, or any combination thereof) in order to use both drive systems to their maximum capacity.

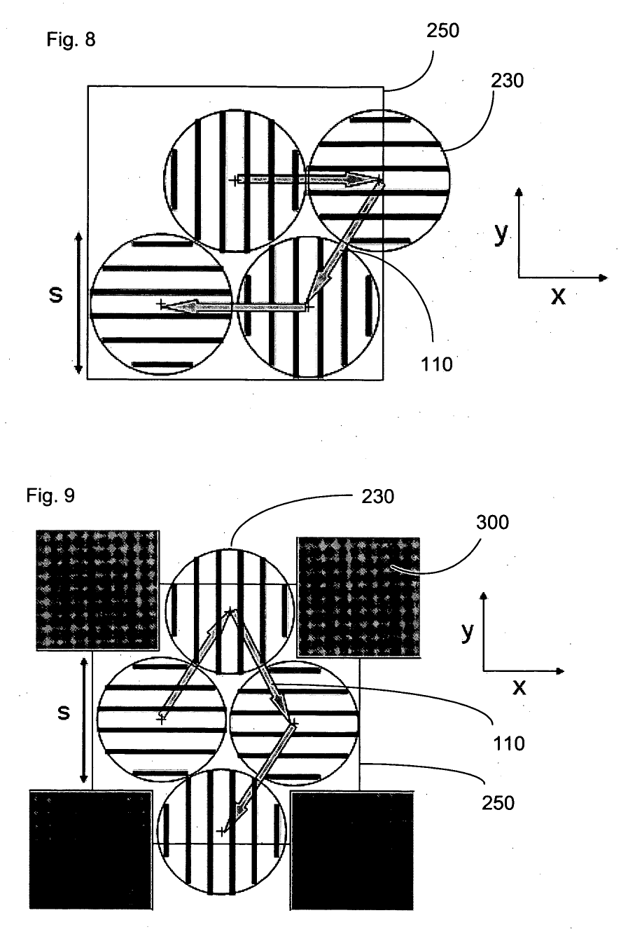

The sub-targets do not have to be square as illustrated in FIGS. 6 and 7. They may be, for example, circular as shown in FIGS. 8 and 9 without loss of size or quality. A circular shape can be packed in different arrangements from square shapes, making it possible to reduce the area on the substrate occupied by the targets. FIG. 8 shows a “honeycomb” or parallelogramic or quadrilateral or hexagonal lattice arrangement for the circular sub-targets 230. The square outline 250 shows the relative size of the same target with square sub-targets. It can be seen that with circular sub-targets 230, the full height of the target is less than 2s. The real estate or space taken up in the scribelane is less than for the squares 210, 220, but the micropath 110 length is the same so the throughput is unaffected. The relative throughput and real estate for each geometry is shown in Table 1 below.

The honeycomb lattice of the sub-targets works particularly well at a crossing of two scribelanes as shown in FIG. 7. Corners 300 are the product die part of the substrate whereas the four circles 230 each with a height s fit into the four entrances of the scribelanes. This arrangement clearly fits better than the square 2×2 arrangement shown by box 250.

In Table 1, calculated throughput is compared with a nominal microstep time of 50 ms with an arrangement as shown in FIG. 6. With a total of 36 targets per substrate, the nominal throughput is 25 seconds per substrate. Particular assumptions are described below.

TABLE 1

| | Throughput (% decrease | Scribelane | |
|---|---|---|---|
| | from nominal value). | real estate | |
| Geometry | For explanation, see later. | per target | Notes |
| 2 × 2 square | Assume 0.5 ms/step is saved | 2s × 2s; | Needs scribelane |
| lattice | on settling time for each of | linear stretch | size of more than 2s. |
| (FIG. 6) | the 3 microsteps: −0.21% | is 2s | |
| 1 × 4 row | Assume 0.5 ms/step is saved | 1s × 4s; | Needs scribelane |
| (FIG. 7) | for 2 out of 3 microsteps: −0.14% | linear stretch | size of more than 1s |
| | | is 4s | to take grace margin |
| | | | into account |
| 45° rotated | Assume 1.0 ms/step is saved | As above, | |
| (FIG. 5) | by using both X and Y | depending on | |
| | drives: −0.43% | lattice used | |
| Honeycomb | Assume 0.5 ms/step is saved | 1.85s × 2.5s; | Needs scribelane |
| lattice | for each of the 3 microsteps: | linear stretch | size of more than |
| (FIG. 8) | −0.21% | is 2.5s | 1.85s (so 15% |
| | | | narrower scribelane |
| | | | can be used) |
| Honeycomb on | Assume 0.5 ms/step is saved | 2.75s × 2s; | Needs scribelane |
| scribelane | for each of the 3 microsteps: | linear stretch | size of more than 1s |
| crossing | −0.21% | in both | (saves 0.5s relative |
| (FIG. 9) | | directions is | to the 1 × 4 row |
| | | about 3.5s | above) |

Advantages of the above include: throughput of the substrates is increased and/or scribelane real estate is decreased. The extra available real estate may be used to add more measurement targets on the substrate, or to increase the target size to improve measurement accuracy and quality. The saved time traveling from target to target and sub-target to sub-target may be reinvested in other time-critical tasks, such as signal measurement, signal acquisition or to improve substrate throughput.

With regard to throughput, it is assumed that a microstep 110 that aligns with the direction of the sub-target grid does not need the full microstep time of 50 ms, but can be completed in 49.5 ms. This is because any residual motion of the substrate will be in the direction of the sub-target grid pattern and would not be visible in a sensor output.

Furthermore, it is assumed that a 40% increase in speed of the movement of the substrate, such as can be achieved by rotating the axis of the substrate relative, translates into a reduction in microstep time of about 1 ms. The reason this is a relatively small gain lies in the fact that most of the 50 ms micro step time is spent on settling.

The scribelane is an area that is useful for varying types of targets, markers and test structures. In Table 1 above, the real estate is measured by linear stretch of the scribelane used.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, metalworking, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A method of measuring a property of a substrate, in a system that comprises at least two drive systems configured to drive the substrate in substantially perpendicular drive directions, the substrate comprising at least two measurement targets for consecutive measurement, the method comprising:
positioning the substrate such that a most economical path between consecutive measurement targets is at an acute angle with respect to at least one of the substantially perpendicular drive directions of the at least two drive systems; and
driving the substrate using both drive systems simultaneously such that their net movement moves the substrate along the angle.

2. The method of claim 1, wherein the angle is dependent on the relative power ratings of the drive systems.

3. The method of claim 1, wherein the angle is 45 degrees.

4. The method of claim 1, wherein the angle is dependent on the relative settling time of the drive systems.

5. The method of claim 1, wherein the angle is determined by simulating or measuring the total travel time between the measurement targets on the substrate for a number of different angles and selecting the shortest total travel time.

6. The method of claim 1, wherein the measurement targets on the substrate are arranged at points on a regular grid in alignment with X and Y axes of the substrate.

7. The method of claim 1, wherein the substrate is driven such that the measurement targets are in line in turn with a measurement beam and the sequence in which the measurement targets are in line with the measurement beam is determined by the most economical path between measurement targets.

8. The method of claim 1, wherein the most economical path is the shortest path.

9. The method of claim 1, further comprising irradiating the measurement targets and detecting the radiation redirected from the measurement targets using a detector, wherein the detector is positioned such that it is at the same angle as the measurement targets with respect to X-Y axes of the substrate such that the measurement targets are aligned with the detector.

10. The method of claim 1, wherein the measurement targets are chosen from a group of shapes that consists of: circular, rectangular and hexagonal, and the measurement targets are positioned with respect to each other in such a way to enable the most economical path between the measurement targets while taking up the least space.

11. The method of claim 10, wherein the measurement targets are positioned in a parallelogramic lattice.

12. The method of claim 10, wherein the measurement targets are positioned in a quadrilateral lattice.

14. The method of claim 12, wherein the measurement targets are positioned at a point on the substrate where two scribelanes cross each other.

15. The method of claim 1, wherein the measurement targets are sub-targets of a larger measurement target.

16. A method of measuring a property of a substrate, in a system that comprises at least two drive systems configured to drive the substrate in substantially perpendicular drive directions, the substrate comprising at least one measurement target for measurement, the method comprising:
positioning the substrate such that a most economical path between a starting point on the substrate and the measurement target is at an acute angle with respect to at least one of the substantially perpendicular drive directions of the at least two drive systems; and
driving the substrate using both drive systems simultaneously such that their net movement moves the substrate along the angle.

17. A method of measuring a property of a substrate, in a system that comprises at least two drive systems, a first drive system configured to drive the substrate in a first drive direction and a second drive system configured to drive a sensor in a second drive direction substantially perpendicular to the first drive direction, the substrate comprising at least two measurement targets for consecutive measurement, the method comprising:
positioning the substrate such that a most economical path between consecutive measurement targets is at an acute angle with respect to at least one of the substantially perpendicular drive directions of the two drive systems; and
driving the substrate and sensor using both drive systems simultaneously such that their net movement moves the substrate along the angle.

18. A loading apparatus for loading a substrate onto a substrate table for subsequent measurement, the substrate table being drivable by at least two drive systems with substantially perpendicular drive directions, the loading apparatus comprising:
a detector configured to detect a marker on the substrate indicating the X-Y axes of the substrate, the X-Y axes being determined by the relative position of measurement targets on the substrate; and
a positioning mechanism configured to position the substrate on the substrate table such that the X-Y axes of the substrate are at an acute angle with respect to at least one of the substantially perpendicular axes of the at least two drive systems.

19. An inspection apparatus configured to measure a property of a substrate, comprising:
a substrate table configured to hold a substrate;
a first drive system configured to drive the substrate table in a first direction;
a second drive system configured to drive the substrate table in a direction substantially perpendicular to the first direction; and
a loader configured to load a substrate onto the substrate table such that a most economical direction of travel between at least a first measurement target and second measurement target on the substrate is at an acute angle with respect to at least one of the drive directions of the first and second drive systems.

20. The inspection apparatus of claim 19, wherein the loader is arranged to detect a marker on the substrate and align the marker with a reference point.

21. The inspection apparatus of claim 20, wherein the marker is a notch in the edge of the substrate.

22. The inspection apparatus of claim 20, wherein the substrate has a substantially curved edge and the marker is a flat portion of the edge of the substrate.

23. A lithographic apparatus configured to measure a property of a substrate, comprising:
a substrate table configured to hold a substrate;
a system configured to transfer a pattern onto a substrate;
a first drive system configured to drive the substrate table in a first direction;
a second drive system configured to drive the substrate table in a direction substantially perpendicular to the first direction; and
a loader configured to load a substrate onto the substrate table such that a most economical direction of travel between at least a first measurement target and second measurement target on the substrate is at an acute angle with respect to at least one of the drive directions of the first and second drive systems.

24. A lithographic cell configured to measure a property of a substrate, comprising:
a lithographic apparatus configured to transfer a pattern to a substrate; and
a track configured to process the substrate,
wherein the lithographic cell comprises:
a substrate table configured to hold a substrate,
a system configured to transfer a pattern onto a substrate,
a first drive system configured to drive the substrate table in a first direction;
a second drive system configured to drive the substrate table in a direction substantially perpendicular to the first direction, and
a loader configured to load a substrate onto the substrate table such that a most economical direction of travel between at least a first measurement target and second measurement target on the substrate is at an acute angle with respect to at least one of the drive directions of the first and second drive systems.

25. A substrate for use in an inspection apparatus configured to measure a property of the substrate, the substrate comprising a measurement target configured to redirect a measurement radiation beam, the measurement target comprising a plurality of sub-targets, the sub-targets being substantially circular and being arranged such that the sub-targets are packed as closely as possible to each other within the measurement target.

26. The substrate of claim 25, wherein the measurement target is positioned at a crossing of two scribelanes on the substrate and the sub-targets are arranged in a substantially quadrilateral lattice within the scribelanes.
